(19) United States
(12) Patent Application Publication
(10) Pub. No.: US 2012/0083725 A1
(43) Pub. Date: Apr. 5, 2012

(54) Protective Tendon Boot for Protecting Horse Legs

(76) Inventor: Peter Mattes, Mahlstetten (DE)

(21) Appl. No.: 13/226,254

(22) Filed: Sep. 6, 2011

(30) Foreign Application Priority Data
Sep. 3, 2010 (DE) 10 2010 044 352.2

(51) Int. Cl. A61D 9/00

(52) U.S. Cl. 602/75

(57) ABSTRACT

A protective tendon boot for protecting horse legs includes an essentially rectangular padding, where the padding includes two longitudinal edges which run in the longitudinal direction of the leg when fastened on the horse leg. A zipper includes having two zipper halves), each of the zipper halves is located being situated in the area of one of the longitudinal edges of the padding, and an overlapping section which covers the entire zipper when the protective tendon boot is fastened on the leg.

### PRIORITY INFORMATION

This application claims priority from German application 10 2010 044 352.2 filed Sep. 3, 2010, which is hereby incorporated by reference.

### BACKGROUND OF THE INVENTION

The present invention relates to a protective tendon boot for protecting horse legs having a mat which has fastening elements for detachably fastening the protective tendon boot on the horse leg.

A protective tendon boot that includes rubber straps as fastening elements is known from published German Patent application DE 42 06 740 A1. On one side of the tendon boot, these rubber straps have closing elements which are hooked into the appropriate closing elements on the opposite side of the tendon boot. Moreover, these rubber straps are detachably connected to the tendon boot by snaps.

When using such rubber elements, there is the risk of wrapping these tendon boots too tightly around the horse leg, thus reducing the comfort for the horse.

A tendon guard for horses is also described in published European Patent application EP 0 727 140 A1 essentially as a mat that can be wrapped around the horse leg with the aid of hook and loop fasteners (e.g., VELCRO® fasteners) and fleece straps and that has a profiled protective cap made of stiffer flexible material being attached on the outside. There is a soft elastic upholstery material underlying this protective cap to eliminate the risk of the tendon boot chafing against the horse leg.

This known tendon boot is also fastened on the horse leg with the aid of Velcro fasteners and fleece straps, so that it is possibly not recognized if these tendon boots are secured too tightly around the horse leg. Furthermore, this tendon boot has a complicated design, so that its manufacture cost is relatively expensive.

The company Julius Zorn GmbH, Aichach, has been recently selling flat-knitted compression bandages for horses. The compression bandages are made of a coarse-meshed and breathable material which has 74% polyamide, 17% spandex and 9% viscose. These compression bandages have a single-ply knitted fabric that is essentially rectangular in shape made of the described material. The longitudinal sides are provided with hooks spaced in relation to one another which have to be hooked into the opposing loops of the mat when putting the bandage on the horse leg. The loops and hooks are covered by an inner fabric strap so that the loops and hooks cannot apply pressure on the horse leg. In addition, an outer zipper is provided, which is to be closed after hooking the hooks into the loops. Furthermore, a tongue, which is fastened in the upper area of the compression bandage put on the horse leg across the upper area with the aid of a Velcro® fastener, is provided for securing the closed zipper. The compression bandage is manufactured in such a way that the zipper running lengthwise runs at the front of the horse leg.

Due to the material used, the compression bandage is not suitable to protect a horse leg against impact or scratching.

### SUMMARY OF THE INVENTION

According to an aspect of the present invention a tendon boot for a horse leg includes padding having two longitudinal edges that run in the longitudinal direction of the leg when fastened on the horse leg; a zipper having two zipper halves wherein each of the zipper halves being situated in the area of one of the longitudinal edges of the padding; and an overlapping section that covers the entire zipper when the protective tendon boot is fastened on the leg.

Advantageously, because of the location of the zipper and its being covered when the protective tendon boot is put on, the protective tendon boot is form-fittingly connected across its entire length so that it is no longer possible to put such a protective tendon boot on the horse leg too tightly. Moreover, the protective tendon boot has a relatively simple design that allows for a cost-effective manufacture.

The zipper halves may each run parallel to a longitudinal edge of the mat, which allows the protective tendon boot to be easily secured to the horse leg. The zipper may be preferably completely covered by the overlapping section, which is preferably situated in one piece on the padding, when the protective tendon boot is put on, the zipper cannot open unintentionally. In addition, the protective tendon boot is nicer to look at if it has no noticeable zipper.

The padding may be made of breathable material, e.g., a fleece or a fabric material. The padding preferably includes a plurality of layers to effectively protect the horse leg against impact and/or scratching.

The protective tendon boot may be arranged in such a way that the zipper rests on the part of the horse leg facing the outside when being put on the horse leg. A reinforcing area (e.g., an even thicker padding or a protective cap made of a firm material such as for example a plastic or leather cap), which is advantageously situated at the central part of the padding, is located opposite the zipper and thus on the inside of the horse leg.

The zipper may be sewed on the padding via a stretching strap lying in-between. The stretching strap of elastic material may also be incorporated in the padding. The purpose is to allow the protective tendon boot to stretch for example by about 1 cm to 3 cm, so that it may be put on differently sized horse legs.

The use of a zipper ensures that the protective tendon boot adjustably and optimally fits the horse leg. In addition, it is easily possible from a manufacturing standpoint to equip the padding with such a zipper, in particular, fully automatically with the aid of sewing machines.

In one embodiment both a zipper and a hook and loop fastener are provided, where a first zipper half situated on the padding runs in a parallel offset manner in relation to one longitudinal edge of the padding to form the overlapping section, and the first part of the Velcro fastener is situated flush with this longitudinal edge. The second part of Velcro fastener may be situated on the padding in the area of the other longitudinal edge on the side of the second zipper half facing away from the longitudinal edge in such a way that the overlapping section is secured by covering the closed zipper when the padding is fastened on the horse leg.

The second zipper half may be situated in a parallel offset manner in relation to the other longitudinal edge of the padding by forming a narrow border, in particular, the width of this border being smaller than the width of the overlapping section.

Advantageously, by locating the fastening elements in the area of the longitudinal edges, a sufficient padding essentially prevents the fastening elements from possibly being pushed in or through to the horse leg. In addition, it is ensured because of the soft, impact-absorbing padding that the horse leg is protected against impact and scratching. By using the zipper over the entire length of the protective tendon boot in the longitudinal direction of the horse leg, the tendon boot is protected at the same time against slipping and fits comfortably. By securing the overlapping section with the aid of a hook and loop fastener, preferably over its entire length in the longitudinal direction of the horse leg, it is at the same time almost impossible for the tendon boot to unintentionally detach from the horse leg.

The padding may be reinforced in its central area using a thickened padding material running in the longitudinal direction of the horse leg in such a way that this padding material protects the part of the horse leg facing inside when the padding is fastened on the horse leg. In this way, the area of the horse leg facing inside is further protected against physical impact.

Preferably, this reinforcing area is designed to have a thickened padding material in the padding. The reinforcing area may have a spoon-like form. It is also possible to insert in or place on the reinforcing area a protective cap for example of leather, firm plastic or the like.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 illustrates the inside of a protective tendon boot;

FIG. 2 illustrates the outside of the protective tendon boot illustrated in FIG. 1;

FIG. 3 illustrates an alternative embodiment protective tendon boot in which the zipper is sewed on the padding using a stretching strap; and

FIG. 4 illustrates yet another alternative embodiment a protective tendon boot that includes a stretching strap incorporated in the padding.

### DETAILED DESCRIPTION OF THE INVENTION

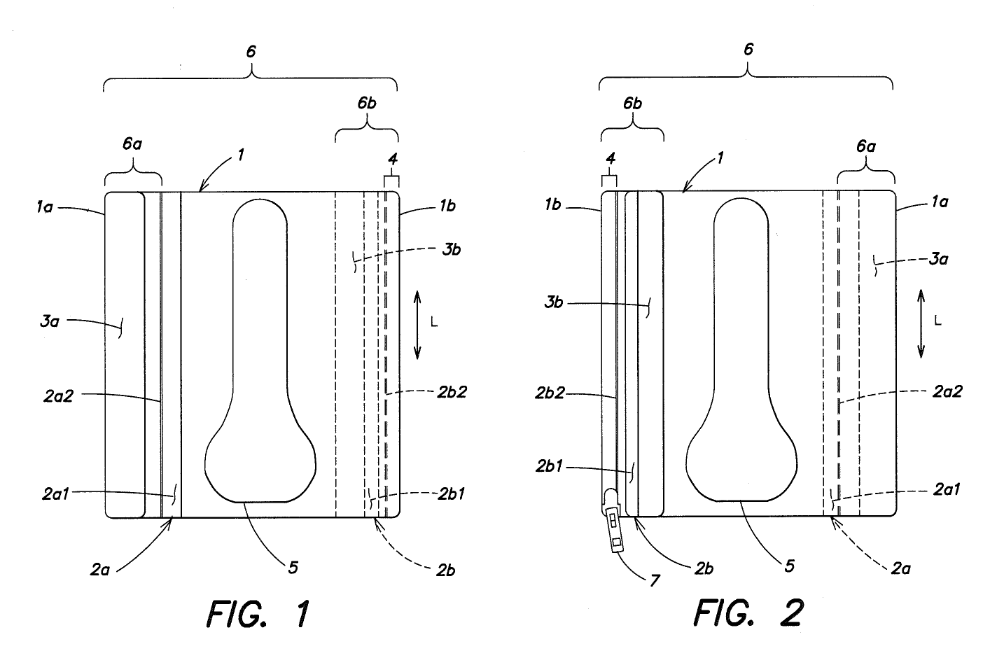

Referring to FIGS. 1 and 2, a protective tendon boot includes a mat 1 (e.g., a rectangular mat), which is referred to as padding 1 hereinafter, having two opposing longitudinal edges 1a and 1b. FIG. 1 illustrates the inside of the padding 1, which is put on a horse leg, and FIG. 2 illustrates the outside of the padding 1 which is also visible when fastened to the horse leg.

The padding 1 encloses the horse leg in such a way that the two longitudinal edges 1a and 1b run in longitudinal direction L of the horse leg and form overlapping section 6 also running in the longitudinal direction L of the horse leg in an area of the horse leg directed outside and away from the horse body, as explained below in greater detail.

In the central area of the padding 1 a spoon-like reinforcing area 5 which is designed here as a thickened padding material and runs in the area of the horse leg pointing toward the middle of the horse when enclosing the horse leg, also extends in the longitudinal direction L. When the horse walks, its legs that move next to each other are effectively protected against impact and scratching, caused by the legs.

The padding 1 of the protective tendon boot has a zipper 2 including two zipper halves 2a and 2b, each having a zipper strap 2a1 and 2b 1, respectively, and zipper teeth 2a2 and 2b2, respectively, running along it, and also a hook and loop fastener 3 (e.g., a Velcro® fastener) including a first part 3a and a second part 3b.

The zipper strap 2a1 of the zipper half 2a is situated on the inside of the padding 1 running in a parallel offset manner in relation to the longitudinal edge 1a, so that a border area 6a is formed whose width corresponds to the distance between the line of the zipper teeth 2a2 and the longitudinal edge 1a, and forms the overlapping section 6 together with the opposing longitudinal edge 1b, when the padding 1 is put around the horse leg.

The first part 3a of the hook and loop fastener may run flush in the longitudinal direction L with the longitudinal edge 1a, this part being designed as a fabric strap with teeth, i.e., a hook strap.

On the outside (see FIG. 2), on the opposing longitudinal edge 1b, the other part 2b of the zipper is situated as the zipper strap 2b1 having the zipper teeth 2b2 and a slider 7 attached to it, and the second part 3b is situated as a fleece strap of the hook and loop fastener.

In this context, the zipper strap 2b1 runs also in a parallel offset manner in relation to the longitudinal edge 1b, so that its line of the zipper teeth 2b2 forms a distance 4 in relation to the longitudinal edge 1b. Parallel, the second part 3b of the hook and loop fastener connects directly to the line of the zipper teeth 2b2 and rests on the side of the line of the zipper teeth 2b2 facing away from the longitudinal edge. From the manufacturing standpoint, the zipper strap 2b1 and the second part 3b (e.g., a fleece strap) are simultaneously connected to the padding 1, by sewing for example.

The opposing edge, in relation to the line of the zipper teeth 2b2, of the second part 3b of the fastener 3 forms a border area 6b on the longitudinal edge 1b, which forms overlapping section 6 together with the border area 6a on the longitudinal edge 1a.

The padding 1 may, for example, be manufactured from a fleece or fabric material, or a polyester fiber cloth, the edges of such a mat, in particular the longitudinal edges 1a and 1b, being edged.

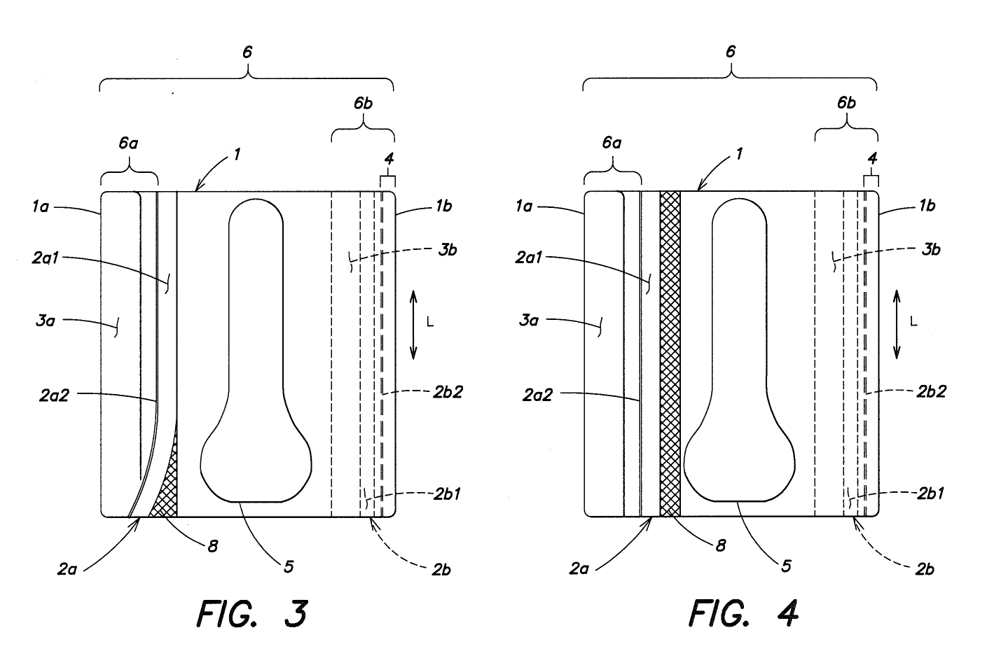

FIG. 3 and FIG. 4 illustrate alternative embodiment protective tendon boots. Referring to FIG. 3, the protective tendon boots have a stretching strap 8 that runs between the zipper strap 2a1 and the padding 1 along for example approximately ⅓ of longitudinal edge 1a as illustrated in FIG. 3. Referring to FIG. 4, the stretching strap 8 is incorporated in the padding 1 over for example the entire length of the protective tendon boot. The stretching strap allows for some stretching of the protective tendon boot, e.g., by about 1 cm to 3 cm, so that it may be put on differently sized horse legs.

Although the present invention has been shown and described with respect to several preferred embodiments thereof, various changes, omissions and additions to the form and detail thereof, may be made therein, without departing from the spirit and scope of the invention.

What is claimed is:

1. A protective tendon boot for protecting horse legs, the tendon boot comprising:
a pad having at least two longitudinal edges which run in the longitudinal direction of the leg when operably fastened to the horse leg;
a zipper having two zipper halves wherein each of the zipper halves is situated in the area of one of the longitudinal edges of the pad; and
an overlapping section that covers the zipper when the protective tendon boot is fastened on the leg.

2. The protective tendon boot of claim 1, wherein the overlapping section is made of the same material as the pad.

3. The protective tendon boot of claim 1, wherein the overlapping section comprises a hook and loop fastener having a first and second part from which each part runs parallel with respect to one of the zipper halves.

4. The protective tendon boot of claim 3, wherein a first zipper half situated on the pad runs in a parallel offset manner in relation to a longitudinal edge of the pad to form the overlapping section, the first part of the hook and loop fastener is situated flush with this one longitudinal edge, and the second part of the hook and loop fastener being situated on the pad in the area of the other longitudinal edge on the side of the second zipper half facing away from the longitudinal edge in such a way that the overlapping section is secured by covering the closed zipper when the pad is fastened on the horse leg.

5. The protective tendon boot of claim 4, wherein the second zipper half runs in a parallel offset manner in relation to the other longitudinal edge of the pad, forming a narrow border.

6. The protective tendon boot of claim 5, wherein the width of the border on the other longitudinal edge is smaller than the width of the overlapping section.

7. The protective tendon boot of claim 1, wherein the pad has a reinforcing area in its central area.

8. The protective tendon boot of claim 7, wherein the reinforcing area in the pad has a spoon-like shape.

9. The protective tendon boot of claim 1, wherein the pad is made of a breathable fabric material having preferably two, three, four or more layers.

10. The protective tendon boot of claim 9, wherein the fabric material is a fleece or a wool material or a mixture of these materials.

11. The protective tendon boot of claim 1, wherein a stretching strap is provided that allows the protective tendon boot to be stretched at least sectionally diagonally to its longitudinal edges.

12. The protective tendon boot as recited in claim 11, wherein the stretching strap is provided between one of the zipper halves and the pad.

13. The protective tendon boot of claim 12, wherein the pad including the overlapping section has an upper area part formed in one piece and a lower area part formed in one piece, each having one of the zipper halves and one of the hook and loop fastener halves sewed on them.
